(19) United States
(12) Patent Application Publication
(10) Pub. No.: US 2015/0033561 A1
(43) Pub. Date: Feb. 5, 2015

(54) LASER MELT PARTICLE INJECTION HARDFACING

(71) Applicants: Gerald J. Bruck, Oviedo, FL (US); Ahmed Kamel, Orlando, FL (US)

(72) Inventors: Gerald J. Bruck, Oviedo, FL (US); Ahmed Kamel, Orlando, FL (US)

(21) Appl. No.: 13/956,521

(22) Filed: Aug. 1, 2013

(51) Int. Cl. F01D 5/28; B23K 26/08; B23K 26/34; F01D 5/14; B23K 26/00

(52) U.S. Cl. CPC F01D 5/288; F01D 5/147; B23K 26/0012; B23K 26/345; B23K 26/0807
USPC 29/889.71; 219/76.14; 219/73.21

(57) ABSTRACT

A method for hardfacing a surface including: depositing a powder (68) having alloy particles onto a surface (70) of a substrate (66); rastering a laser beam (60) across the surface to melt the powder and to form a weld pool (78) having a width (64); directing particles (74) of a material exhibiting a different property than the substrate into the weld pool in a spray pattern having a width less than the width of the weld pool; and establishing the rastering and directing steps such that material circulation within the weld pool is effective to distribute the particles in the weld pool into a pattern having a width greater than the width of the spray pattern prior to re-solidification of the weld pool.

### FIELD OF THE INVENTION

The invention relates to laser cladding of a substrate including hard particle injection.

### BACKGROUND OF THE INVENTION

During laser microcladding a layer of material is deposited onto a surface by using a laser beam to melt a flow of powder directed toward a substrate surface to be clad. The powder is propelled toward the surface by a jet of gas, and when the powder is a reactive alloy material, the gas is chosen to be argon or other inert gas which shields the molten alloy from atmospheric oxygen and nitrogen. Laser microcladding is limited by its low deposition rate, such as on the order of 1 to 6 cm³/hr. Furthermore, because the protective argon shield tends to dissipate before the clad material is fully cooled, superficial oxidation and nitridation may occur on the surface of the deposit, which is problematic when multiple layers of clad material are necessary to achieve a desired cladding thickness.

In a variation of conventional laser cladding particles may be injected into the weld pool. The injected particles are captured by the meld pool which then solidifies around the particles, thereby metallurgically bonding the particles to the solidified weld pool material. The injected particles are often selected for properties that are different than that of the substrate. One example includes injecting hard particles into a weld pool formed at a tip of a gas turbine engine blade. The hard particles in the resulting blade tip offer better wear resistance for those instances when the blade tip may rub against an abradable blade ring disposed just outside a sweep of the blade tip.

U.S. Pat. No. 4,299,860 to Schaefer discloses a technique for injecting particles into a weld pool (melt). Schaefer discloses injecting these particles in a vacuum environment to maintain quality of the weld pool. U.S. Pat. No. 4,981,716 to Sundstrum discloses injecting particles without a vacuum, but instead by carrying the particles with an inert gas, such as argon or helium. Sundstrum further improved the process by introducing surfaces to reflect scattered particles back into the melt and thereby enhance a capture efficiency of the particles. It is also known to pre-place stainless steel powder onto a carbon steel substrate with powdered flux material. In this technique the powdered flux provides shielding of the melt pool instead of the inert shielding gas.

It is further recognized that superalloy materials, such as those that form a turbine blade, are among the most difficult materials to weld/clad due to their susceptibility to weld solidification cracking and strain age cracking. The term “superalloy” is used herein as it is commonly used in the art; i.e., a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g. IN 738, IN 792, IN 939), Rene alloys (e.g. Rene N5, Rene 80, Rene 142), Haynes alloys, Mar M, CM 247, CM 247 LC, C263, 718, X-750, ECY 768, 282, X45, PWA 1483 and CMSX (e.g. CMSX-4) single crystal alloys. An improved method for welding/cladding superalloys is disclosed in commonly assigned U.S. patent application Ser. No. 13/755,098, filed on 31 Jan. 2013, attorney docket number 2012P28301 US, publication number XXX, which is hereby incorporated by reference in its entirety.

### BRIEF DESCRIPTION OF THE DRAWINGS

The invention is explained in the following description in view of the drawings that show:

FIGS. 1 and 2 show a prior art technique of laser cladding with particle injection.

FIG. 3 shows a side view of an exemplary embodiment of laser cladding with particle injection.

FIG. 4 shows a top view of the exemplary embodiment of laser cladding with particle injection of FIG. 3.

FIG. 5 shows a side view of an alternate exemplary embodiment of laser cladding with particle injection.

FIG. 6 shows a top view of yet another exemplary embodiment of laser cladding with particle injection.

### DETAILED DESCRIPTION OF THE INVENTION

The present inventors have developed a laser cladding particle injection process that captures more injected particles in the melt while maintaining sufficient particle distribution within the melt, thereby improving manufacturing efficiency. In an exemplary embodiment the process may use a powdered flux instead of a vacuum environment or inert gas to protect the weld pool and consequently the process is able to clad the most difficult to clad superalloy materials. The powdered flux material of an exemplary embodiment is effective to provide beam energy trapping, impurity cleansing, atmospheric shielding, bead shaping, and cooling temperature control in order to accomplish crack-free joining of a wide variety of superalloy materials.

FIG. 1 shows a side view of a prior art laser cladding particle injection technique that occurs in a vacuum. A conventional laser beam 10 is directed toward a substrate 12 to form a weld pool (melt) 14 that may include a small portion of the substrate 12 that has been melted. The conventional laser beam 10 travels in a direction of travel 16, and therefore the weld pool 14 also travels in the same direction of travel 16. Particles 18 are injected into a target area 20 between a back side 22 of the conventional laser beam 10 and a perimeter 24 of the weld pool 14 behind the back side 22 of the conventional laser beam 10. Upon solidification of the weld pool 14 a conglomerate deposit 26 is achieved with entrapped particles 18 that remain discrete but which may metallurgically bond to the conglomerate deposit 26. The conventional laser beam 10 forms a very small interface 28 with the substrate 12, melts a small amount of the substrate 12, and therefore forms a relatively small weld pool 14. Consequently, the target area 20 is also relatively small. Conventional techniques direct the particles into the target area 20 as best as possible, but due to the relatively small target area 20 some particles may not reach the target area and may instead be deflected off the substrate 12 as indicated by deflected particle 30. Similarly, some particles may strike a surface 32 of the weld pool 14 and ricochet due to an angle 34 of the particle's trajectory 36 to the surface 32 of the weld pool.

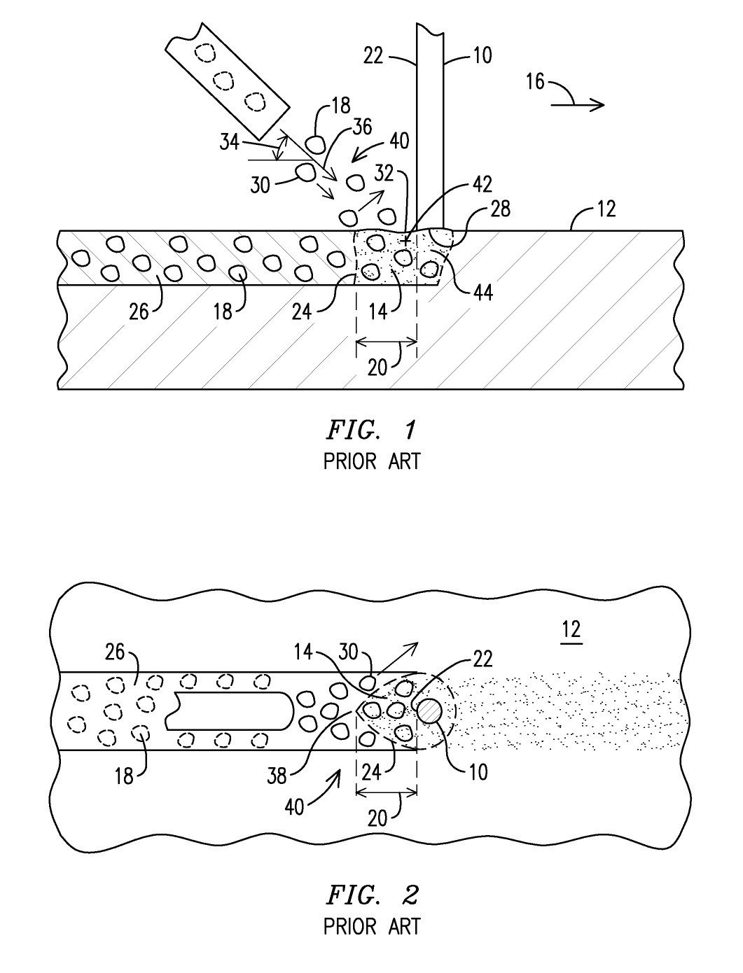

FIG. 2 shows a top view of the prior art laser cladding particle injection technique of FIG. 1. Here it can be seen that the perimeter 24 of the weld pool 14 forms a tear drop shape that narrows. This narrowing toward a back side 38 of the tear drop shape reduces a size of the target area 20. In this area a greater percentage of directed particles 18 may be deflected, in particular if a cross sectional shape of a stream 40 of particles 18 is round. In such a configuration there may be many deflected particles 30 near the back side 38 of the weld pool 14. In addition, in conventional configurations a target location 42 (FIG. 1) for the particle injection may be tied to a focal point 44 of the conventional laser beam 10. Thus, when the focal point 44 is at a certain location in the substrate 12 the target location 42 will coincide approximately with an ideal aiming point in the weld pool 14. However, in certain instances it may be desirable to defocus the laser beam, moving the focal point 44 up or down. In such instances the target location 42 may also move up and down. This, in turn, moves the target location 42 from the ideal aiming point and may result in a greater amount of deflected particles 30 because the stream 40 of particles is no longer properly aimed. As a result of these limitations, to the inventor's knowledge a capture efficiency of particles has not been known to exceed about 60% of the particles that are directed toward the weld pool.

The present inventors have recognized that technology that has been known in the art has been improved to the point where it can be combined in an innovative process that overcomes the long-standing limitations of the prior laser cladding particle injection processes. Specifically, the inventors propose to use laser scanning (rastering) optics to form a weld pool of greater size. This, in turn, allows for a greater capture rate of injected particles by ensuring that dimension of the weld pool formed by laser scanning are greater than a pattern of a stream of injected particles. The action of the laser and of currents within the weld pool (e.g. the Marangoni effect) help to distribute the particles into those peripheral parts of the weld pool into which particles are not directly injected. Together these mechanisms allow for a greater capture rate of the particles in the weld pool and a sufficiently even distribution of particles throughout the entire volume of the weld pool. In addition, when using a powder flux, the process disclosed herein can be applied to a greater variety of superalloys then ever before. The particles may be characterized by a different characteristic than the substrate. For example, the particles may be harder, as may be desired if the cladding is to produce a more wear-resistant surface. Materials characterized by a greater hardness include, but are not limited to: tungsten carbide, titanium nitride, and diamond. Alternately, the particles may have a greater lubricity etc.

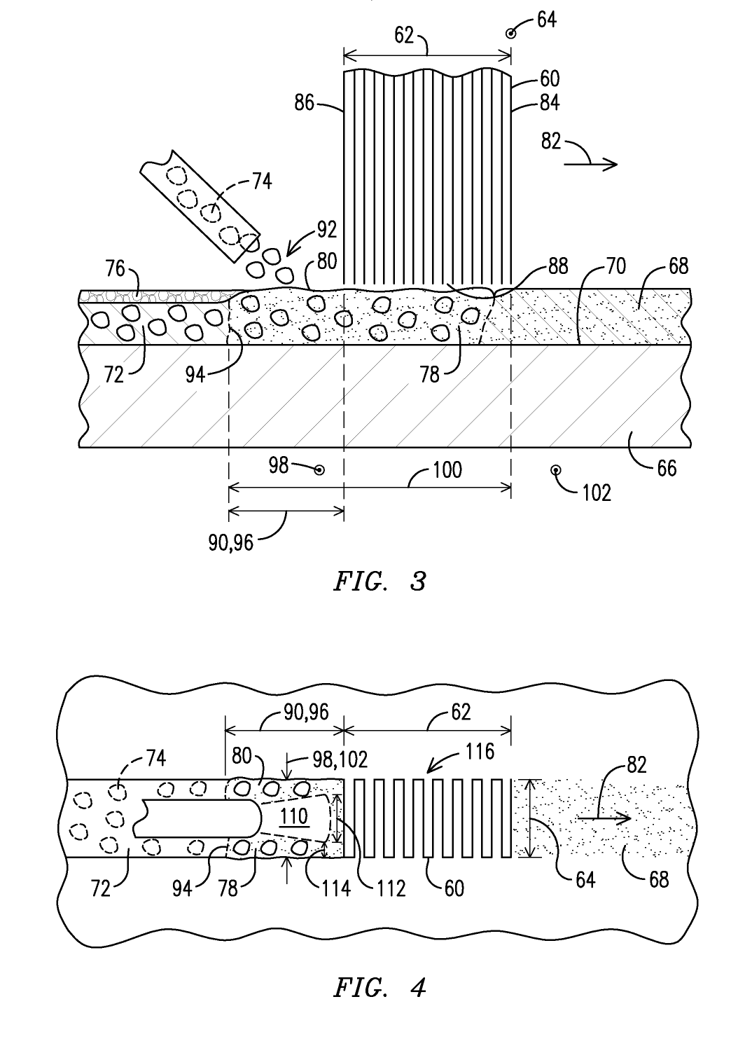

FIG. 3 shows an exemplary embodiment of the laser cladding particle injection processes. A laser beam 60 generated by a laser arrangement (not shown) may be rastered along a length 62 and a width 64 to form a rastered area (not visible) on a substrate 66. The laser beam may be any sufficient type, including but not limited to CO2, NdYAG, fiber, slab and diode. A powder 68 may optionally be preplaced on a surface 70 of the substrate 66 and may include metal/alloy particles and/or powdered flux. The metal particles may be made of a single alloy (or superalloy) having the same or different composition than that of the substrate 66 such that a subsequently formed conglomerate deposit 72 may have particles 74 trapped in a layer having a same composition as the substrate 66. Alternately, the metal particles may be composite particles containing more than one alloy (and/or superalloy) each. Thus, the powder 68 may include any combination of particles made of single alloys (or superalloys) and composite particles containing more than one alloy (and/or superalloy) each. The powder 68 may include typical wrought alloys, such as alloy nickel alloy 625 powder. In addition, superalloys of useful application include, but are not limited to: CM-247; Rene® 80, 142, and N5; Inconel® 718, X750, 738, 792, and 939; PWA 1483 and 1484; C263; ECY 768; and CMSX-4, and X45. The particles may be approximately 25-100 microns.

In an exemplary embodiment the powder 68 includes a powder flux. Flux may be necessary because gas shield may not adequately cover the larger weld pool 78, and the gas shielding may be more readily displaced and leave the weld pool 78 exposed to the atmosphere. When powder flux is present an overlying layer of protective slag 76 may be formed on the conglomerate deposit 72 upon solidification of the weld pool 78. Typical fluxes for nickel alloy submerged arc welding and electroslag welding may be used in the process described herein for a nickel based superalloy. Examples include Special Metals NT100, Lincoln P2007, Bohler Soudokay NiCrW-412, ESAB OK 10.90, Sandvik 50SW, Sandvik 59S, Bavaria WP-380, Avesta 805, and Oerlikon OP76. Other fluxes typically used for coated electrodes or flux cored electrodes may also be effective.

Various exemplary embodiments are envisioned for the process. In one exemplary embodiment no powder is used. Particles 74 are simply injected into the weld pool 78 in a manner effective to create a greater capture ratio than previously available. The rastering of the laser beam 60 itself may be used to help distribute the particles 74 throughout the weld pool 78. The powder 68 may include alloy particles, composite alloy particles, flux, or any combination thereof. If no flux powder is used the welding operation may occur in a vacuum environment or an inert gas may be supplied to protect the weld pool 78. Any powder 68 that is used may be preplaced, separately fed using one feed path for the powder 68, discrete feed paths for each constituent of the powder 68, and any combination of feed paths and constituents. Further, the powder 68 may be fed through the same feed path used to deliver the particles 74.

When the powder 68 is used and if it contains flux, the powder 68 may be placed ahead of the laser beam 60. In such an exemplary embodiment the powder flux and trailing blanket of slag may provide sufficient shielding. However, it would be necessary to ensure that the particles 74 settle into the weld pool 78 through any floating and likely molten slag that may form. The powder 68 with flux may alternately be fed behind the laser beam 60. This may provide good shielding, but it would be necessary to ensure that the molten slag be fluid enough to shield the entire melt zone, including any zone astride the laser beam 60. This exemplary embodiment may require a run-on tab at the beginning. During subsequent steady state operation the flux and slag should be effective to provide the desired effects. Powder flux may alternately be fed as a separate stream of material, ahead of, coincident with, or behind the laser beam 60. This provides great flexibility in terms of delivery, though it may add some complexity due to the logistics associated with a separate delivery path for the powder flux. In another alternate exemplary embodiment, it is possible to precoat the surface 70 of the substrate 66 with the powder flux. This avoids the need to mix and deliver the powder flux. However, it would be necessary to ensure a sufficient amount of powder flux is delivered. This may require an additional processing step prior to the cladding operation, but the benefits of eliminating the delivery step during the cladding operation may provide other benefits.

While rastering over both the length 62 and width 64 of the rastered area, the laser beam 60, and hence the rastered area, both move in a direction of travel 82 along the substrate 66. As a result, the rastered area has a leading edge 84 and a trailing edge 86. By virtue of a larger interface 88 between the rastered area and the material to be melted a larger weld pool 78 is formed when compared to the weld pool of the conventional technique of FIGS. 1-2. The larger weld pool 78 remains liquid for a longer time, and therefore a target area 90 behind the trailing edge 86 of the rastered area is larger than the target area 20 of FIGS. 1-2. This larger target area 90 is more efficient at capturing a stream 92 of particles 74, resulting in a greater capture ratio of at least 60%. In an exemplary embodiment the length 62 of the rastered area may be 5-10 mm and the width 64 may be 3-10 mm. A perimeter 94 of the weld pool 78 defines a length 96 of the target area 90 that may be about 7-8 mm and a width 98 of the target area that may be about 3-10 mm. The resulting weld pool 78 may then have a length 100 of 12-18 mm and a width 102 of 3-10 mm. These dimensions are indicative of those possible with the process as disclosed herein. However, larger and/or smaller dimensions are also possible. Also, the weld pool 78 may not be exactly the same size as the rastered area due to localized melting and/or solidifying at the edges of the weld pool 78. Should it be desired that the particles 74 maintain as much of their original shape as possible the particles 74 may be directed toward the rear of the weld pool 78.

In FIG. 4 it can be seen that in an exemplary embodiment a pattern of the stream 110 of particles is characterized by a width 112 transverse to the direction of travel 82 that is smaller than the width 98 of the weld pool 78 where the stream 110 and a surface 80 of the weld pool 78 interface (i.e. where the particles 74 enter the weld pool). Likewise the pattern of the stream 110 is characterized by a length (not visible) that is smaller than the length 96 of the weld pool 78. As a result there is a peripheral region 114 between the perimeter 94 of the weld pool 78 into which particles 74 are not directly injected. Nonetheless, the rastering motion of the laser beam 60 acts to stir the weld pool 78 and this stirring, together with natural currents (e.g. convective currents) within the weld pool 78, work together to distribute the particles 74 into the peripheral region 114. Consequently, particles 74 are distributed sufficiently throughout an entire volume of the weld pool 78, not just where the stream 110 is aimed. In an exemplary embodiment the width 112 of the stream 110 may be as little as 75%, or even 50% of the width of the target area 90. In an alternate exemplary embodiment instead of being a fanned-out pattern as shown, the stream 110 may be smaller and may raster with the laser beam 60 in the area surrounded by the peripheral region 114. Alternately, the narrowed stream 110 may move in its own distinct pattern in the area surrounded by the peripheral region 114.

The powder flux and resultant layer of slag 76 provide a number of functions that are beneficial for preventing cracking of the conglomerate deposit 72 and the underlying substrate 66. First, they function to shield both the region of weld pool 78 and the solidified (but still hot) conglomerate deposit 72 from the atmosphere in the region downstream of the rastered area 116. The slag 76 floats to the surface 80 of the weld pool 78 to separate the molten or hot metal from the atmosphere, and the flux may be formulated to produce a shielding gas in some embodiments, thereby avoiding or minimizing the use of expensive inert gas. Second, the slag 76 acts as a blanket that allows the solidified conglomerate deposit 72 to cool slowly and evenly, thereby reducing residual stresses that can contribute to post weld reheat or strain age cracking. Third, the slag 76 helps to shape the weld pool 78 to keep it close to a desired height/width ratio. Fourth, the powder flux provides a cleansing effect for removing trace impurities such as sulfur and phosphorous which contribute to weld solidification cracking. Such cleansing includes deoxidation of the metal powder. Because the flux powder is in intimate contact with the metal powder, it is especially effective in accomplishing this function. Finally, the powder flux may provide an energy absorption and trapping function to more effectively convert the laser beam 60 into heat energy, thus facilitating a precise control of heat input, such as within 1-2%, and a resultant tight control of material temperature during the process. Additionally, the flux may be formulated to compensate for loss of volatized elements during processing or to actively contribute elements to the deposit that are not otherwise provided by the metal powder itself. Together, these process steps produce crack-free deposits of superalloy cladding on superalloy substrates at room temperature for materials that heretofore were believed only to be joinable with a hot box process or through the use of a chill plate.

In an alternate exemplary embodiment the rastered point laser beam of FIGS. 3 and 4 may instead be a rectangular laser beam emitted from a diode laser. In such an exemplary embodiment the diode laser beam may travel back and forth along a swept area that would be comparable to the rastered area 116. In another exemplary embodiment the laser beam may be defocused to increase the size of the weld pool 78.

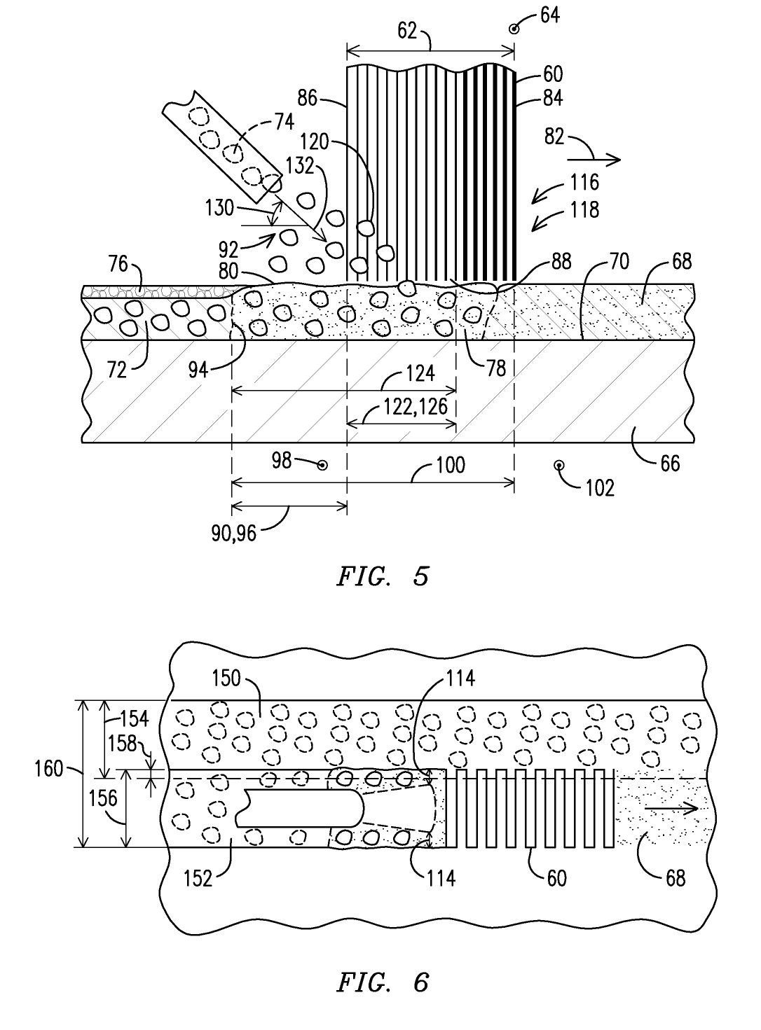

FIG. 5 shows an alternate exemplary embodiment of the laser cladding particle injection processes. In this exemplary embodiment the rastered area 116 is characterized not by a constant energy distribution, but instead by an energy gradient from the leading edge 84 to the trailing edge 86 as indicated by the different line thicknesses. For example, the energy density may be greatest at the leading edge 84 and gradually decrease, either linearly or non-linearly, to a lesser energy density at the trailing edge 86. Such an arrangement would provide the extra energy necessary to change the phase of the substrate 66 from solid to liquid at the leading edge 84, and would reduce the energy delivered to the already-melted weld pool 78 so that the weld pool would remain melted but not acquire any more energy than necessary to do so. This may reduce the amount of heat delivered to the substrate material surrounding the weld pool 78, and this may reduce cracking etc.

In a variation of the of this alternate exemplary embodiment the particles 74 may be directed such that they traverse a column 118 above the rastered area 116 in which the laser beam 60 moves. Due to the speed of the laser beam 60 within the column 118 the particles 74 will inevitably traverse the laser beam 60. The energy gradient may be set so that a surface 120 of the particles 74 is melted but the bulk of the particles 74 remain unmelted. This may be used for any number of reasons, including to enhance metallurgical bonding with the subsequently formed conglomerate deposit 72, and to smooth out irregular surfaces if deemed desirable etc. Some or all of the stream 92 may traverse the column 118.

At some point within the column 118 the energy density would rise to a point where the particles would likely fully melt due to the increased energy density and the increased length of travel through the column 118. Before reaching this point the particles may be considered to be within a safe zone 122 within the column 118. Consequently, in this alternate exemplary embodiment a new target area 124 is created which includes the target area 90 of the exemplary embodiment of FIG. 3 plus a length 126 of the safe zone 122. This is much larger than the target area 90 of the exemplary embodiment of FIG. 3. Consequently more particles 74 are likely to be captured and this would increase the capture ratio even more. Controlling the capture rate of the particles may allow further control of the solidification of the weld pool 78 because the relatively cool mass of the particles 74 will cool the weld pool 78.

In another alternate exemplary embodiment the angle 130 of the particle trajectory with respect to the surface 80 of the weld pool 78 can be increased due to the greater amount of available room in the target zone 90. The increase in the angle 130 decreases the likelihood of deflection, and hence increases the capture ratio.

In an alternate exemplary embodiment of the above process shown in FIG. 6 a first row 150 of cladding may be formed and followed by a second row 152. The first row may occupy a first footprint 154 and the second row may occupy a second footprint 156. There may be an overlap 158 of the two footprints 154, 156 and the overlap 158 may be arranged so that any lower density of particles in the peripheral region 114 of any row may be corrected when the next row is applied so that a density of particles across a width 160 of both rows 150, 152 is made more uniform.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method comprising:
depositing a powder comprising alloy particles onto a surface of a substrate;
rastering a laser beam across the surface to melt the powder and to form a weld pool comprising a width;
directing particles of a material exhibiting a different property than the substrate into the weld pool in a spray pattern having a width less than the width of the weld pool; and
establishing the rastering and directing steps such that material circulation within the weld pool is effective to distribute the directed particles in the weld pool into a pattern having a width greater than the width of the spray pattern prior to re-solidification of the weld pool.

2. The method of claim 1, wherein the substrate comprises a superalloy material, and further comprising:
selecting the powder to comprise alloy particles comprising at least one superalloy material and particles comprising a flux material, wherein melted flux material circulating upward in the weld pool forms a protective slag; and
removing the protective slag upon solidification to reveal the directed particles embedded in re-solidified superalloy material.

3. The method of claim 2, further comprising establishing the rastering and directing steps such that the relative widths of the spray pattern and the weld pool are effective to create a rate of capture of the directed particles in the weld pool of at least 60 percent.

4. The method of claim 1, wherein the material of the directed particle comprises a hardness greater than a hardness of the substrate.

5. A method, comprising:
rastering a laser beam across a surface of a substrate to melt a portion of the substrate and to form a weld pool; and
directing a stream of hard particles comprising a greater wear resistance than the substrate into the weld pool such that upon solidification of the weld pool the hard particles are imbedded therein,
wherein the weld pool solidifies under an overlying layer of slag, and
wherein a perimeter of the stream where entering the weld pool fits within a perimeter of the weld pool.

6. The method of claim 5, further comprising using the rastering to distribute the hard particles within the weld pool.

7. The method of claim 5, further comprising feeding into the weld pool only one of: a powder comprising alloy particles comprising at least one superalloy material; and a flux powder.

8. The method of claim 5, further comprising depositing on the surface a layer of powder comprising at least one of: alloy particles comprising at least one superalloy material; and a flux powder.

9. The method of claim 8, wherein the layer of powder comprises either:
a sublayer comprising: the alloy particles comprising at least one superalloy material; and a discrete sublayer of the flux powder; or
a mixture comprising: the alloy particles comprising at least one superalloy material; and the flux powder.

10. The method of claim 5, further comprising feeding into the weld pool powder comprising at least one of: alloy particles comprising at least one superalloy material; and flux, using a same feed path used for the hard particles.

11. The method of claim 5, further comprising creating an energy gradient within column defined by a rastering of the laser beam, wherein a leading edge of the column comprises a greater energy density than a trailing edge.

12. The method of claim 11, further comprising ensuring the energy density at the trailing edge is sufficient to maintain the weld pool under the column but insufficient to fully melt hard particles that traverse the trailing edge of the column.

13. The method of claim 5, wherein a portion of the weld pool outside the perimeter of the stream where entering the weld pool fills with hard particles via convective mixing or laser induced turbulence in the weld pool.

14. A method of forming a gas turbine engine blade comprising the method of claim 5.

15. A method, comprising:
placing powdered superalloy metal and flux material on a surface of a substrate, the surface forming a tip of a superalloy gas turbine engine blade;
melting the powdered superalloy metal, the flux material, and a portion of the surface of the superalloy substrate to form a weld pool using a laser beam; and
directing a stream of hard particles into the weld pool such that upon solidification of the weld pool the hard particles are distributed throughout and imbedded therein, the hard particles comprising a greater wear resistance than the superalloy substrate,
wherein an interface between the stream and a surface of the weld pool is selected to achieve a rate of capture of the hard particles of at least 60 percent.

16. The method of claim 15, wherein a width of the stream transverse to a direction of travel of the weld pool with respect to the substrate is less than 90 percent of a width of the weld pool.

17. The method of claim 15, wherein the solidified portion forms a first weld bead defining a first footprint on the surface, the method further comprising forming a second weld bead by repeating the placing, melting, and directing steps, wherein the second weld bead overlaps the first footprint, effective to increase a number of hard particles within the overlapped portion of the first footprint.

18. The method of claim 15, further comprising rastering a laser beam across the surface to form the weld pool, wherein a rastering action of the laser beam is selected to enhance distribution of the hard particles throughout the weld pool.

19. The method of claim 18, wherein a rastered area comprises a length in a direction of travel of the weld pool with respect to the substrate of over 5 mm and a width of over 3 mm.

20. The method of claim 19, wherein the rastered area comprises a length of at least 10 mm and a width of at least 5 mm, and the weld pool comprises a length of 17 mm.
